(19) United States
(12) Patent Application Publication
(10) Pub. No.: US 2026/0132867 A1
(43) Pub. Date: May 14, 2026

(54) VIBRATION-BASED HEALTH MONITORING SYSTEM FOR VALVES OF A GAS DELIVERY SYSTEM

(71) Applicant: LAM RESEARCH CORPORATION, Fremont, CA (US)

(72) Inventors: Govinda RAJ, Bangalore (IN); Anthony CONTRERAS, Stockton, CA (US)

(21) Appl. No.: 19/478,073

(22) PCT Filed: Apr. 8, 2024
(86) PCT No.: PCT/US2024/023526

§ 371 Date: Oct. 23, 2025

Related U.S. Application Data
(60) Provisional application No. 63/461,744, filed on Apr. 25, 2023.

(51) Int. Cl. F16K 37/00; G01D 5/353; G01M 13/003

(52) U.S. Cl. CPC F16K 37/0041; F16K 37/0083; G01D 5/35316; G01M 13/003

(57) ABSTRACT

A health monitoring system for a valve of a gas delivery system includes a fiber Bragg grating sensor configured to measure vibration of the valve of the gas delivery system. An optical fiber is connected to the fiber Bragg grating sensor. A reader is connected to the optical fiber and is configured to read the fiber Bragg grating sensor and generate a vibration signal.

### CROSS-REFERENCE TO RELATED APPLICATIONS

This application claims the benefit of U.S. Provisional Application No. 63/461,744, filed on Apr. 25, 2023. The entire disclosure of the application referenced above is incorporated herein by reference.

### FIELD

The present disclosure relates to gas delivery systems for substrate processing systems, and more particularly to vibration-based health monitoring systems for valves of gas delivery systems for substrate processing systems.

### BACKGROUND

The background description provided here is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Substrate processing systems may be used to treat substrates such as semiconductor wafers. The substrate treatments may include deposition, etching, cleaning, and/or other substrate treatments. A substrate is arranged on a substrate support such as an electrostatic chuck (ESC) in a processing chamber. During processing, a gas delivery system introduces gas mixtures into the processing chamber using a showerhead, an injector, and/or other gas delivery device and plasma may be used to initiate chemical reactions.

The gas delivery system typically includes a gas box with valves, gas delivery lines, mass flow controllers, manifolds, and/or other components that deliver the gas mixtures to the processing chamber. For example, the gas delivery system may be used to deliver an etch gas mixture to the processing chamber during etching. Variations in delivery of the gas mixture caused by faulty valves controlling the gas sources increase substrate non-uniformity. For example, a seal and/or diaphragm failure in one or more of the valves may cause variations in a flow rate and/or chemistry of the gas mixture to the processing chamber.

In some substrate processing systems, a weight of the substrate may be measured by a metrology system after processing and compared to a predetermined weight to detect substrate non-uniformity. However, by the time the defective valve is detected using metrology, the valve has already failed.

### SUMMARY

A health monitoring system for a valve of a gas delivery system includes a fiber Bragg grating sensor configured to measure vibration of the valve of the gas delivery system. An optical fiber is connected to the fiber Bragg grating sensor. A reader is connected to the optical fiber and is configured to read the fiber Bragg grating sensor and generate a vibration signal.

In other features, a controller configured to receive the vibration signal and to generate a valve health indicator for the valve based on the vibration signal. A manifold is connected to the valve. The fiber Bragg grating sensor is attached to the manifold.

In other features, the valve includes a diaphragm and the fiber Bragg grating sensor is attached to the diaphragm.

In other features, the valve includes a housing, a feedthrough arranged in an opening in the housing, and a valve component arranged in the housing. The fiber Bragg grating sensor is attached to the valve component. The optical fiber passes through the feedthrough and is connected to the fiber Bragg grating sensor attached to the valve component.

In other features, the feedthrough is welded to the housing. The feedthrough is bonded to the housing.

In other features, the valve includes at least one of an upper piston and a lower piston. The fiber Bragg grating sensor is one of attached to the at least one of the upper piston and the lower piston.

In other features, the controller is configured to compare the vibration signal to a predetermined vibration signature and to generate the valve health indicator in response to the comparison. The controller is configured to compare the vibration signal to a predetermined vibration threshold and to generate the valve health indicator in response to the comparison. The gas delivery system includes a plurality of the fiber Bragg grating sensor to sense vibration at a plurality of locations of the valve. The plurality of the fiber Bragg grating sensor are arranged along a length of the optical fiber.

In other features, the valve comprises a pneumatic valve.

In other features, the fiber Bragg grating sensor is constrained and further comprising a second fiber Bragg grating sensor that is unconstrained.

A method for monitoring health of a valve of a gas delivery system includes sensing vibration of the valve of the gas delivery system using a fiber Bragg grating sensor; coupling light between the fiber Bragg grating sensor and a reader using an optical fiber; and reading the fiber Bragg grating sensor to sense vibration of the valve of the gas delivery system and generating a vibration signal.

In other features, the method includes generating a valve health indicator for the valve of the gas delivery system based on the vibration signal. The method includes attaching the fiber Bragg grating sensor to a manifold connected to the valve. The method includes attaching the fiber Bragg grating sensor to a diaphragm of the valve.

In other features, the method includes arranging the fiber Bragg grating sensor in a housing of the valve; using a feedthrough arranged in an opening in the housing; and feeding an optical fiber through the feedthrough to the fiber Bragg grating sensor.

In other features, the method includes welding the feedthrough in the opening of the housing. In other features, the method includes bonding the feedthrough in the opening of the housing. The method includes comparing the vibration signal to a predetermined vibration signature and generating the valve health indicator in response to the comparison. The method includes comparing the vibration signal to a predetermined vibration threshold and generating the valve health indicator in response to the comparison.

In other features, the method includes using a plurality of the fiber Bragg grating sensor; constraining a first one of the plurality of fiber Bragg grating sensor; and not constraining a second one of the plurality of fiber Bragg grating sensor. The method includes calibrating the first one of the plurality of fiber Bragg grating sensor using the second one of the plurality of fiber Bragg grating sensor.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a functional block diagram of an example of a substrate processing system including a gas delivery system with valves including one or more fiber Bragg grating sensors to detect vibration of the valve according to the present disclosure;

FIG. 2 is a side cross-sectional view of an example of a valve;

FIG. 3 is a side cross-sectional view of an example of a fiber Bragg grating sensor arranged in an optical fiber;

FIG. 4 is a graph showing an example of a core refractive index of the fiber Bragg grating sensor as a function of length;

FIG. 5 are graphs illustrating examples of magnitudes of input, transmitted, and reflected light incident upon a fiber Bragg grating sensor as a function of wavelength;

FIG. 6 is a side cross-sectional view of an example of a group of valves connected to a manifold and including fiber Bragg grating sensors mounted to an outer surface of the manifold according to the present disclosure;

FIG. 7 illustrates an example of a group of valves connected to a manifold and including fiber Bragg grating sensors arranged inside housings of the valves according to the present disclosure;

FIG. 8 is a plan view of an example of a diaphragm of the valve including one or more fiber Bragg grating sensors according to the present disclosure;

FIG. 9 is a plan view of an example of an O-ring of the valve including one or more fiber Bragg grating sensors according to the present disclosure;

FIG. 10 to 12 are side cross-sectional views of examples of valves including one or more fiber Bragg grating sensors arranged inside housings of the valves according to the present disclosure;

FIG. 13 is a functional block diagram of an example of a health monitoring system for monitoring vibration of valves of a gas delivery system according to the present disclosure; and

FIG. 14 is a flowchart of an example of a method for operating the health monitoring system according to the present disclosure.

In the drawings, reference numbers may be reused to identify similar and/or identical elements.

### DETAILED DESCRIPTION

A gas delivery system for a substrate processing system includes valves that are connected to gas sources and that are opened and closed during substrate processing. The gas delivery system is configured to supply process gas mixtures (including two or more gases), purge gases, and/or inert gases. While the valves are typically rated for a relatively high number of cycles without failure, the valves tend to fail early in some applications. The valves may fail due to diaphragm leaks, partial pressure, seal surface leaks, and/or other failure modes. The valve failures may be related to a cycle frequency of the valves (e.g., an increasing number of valve failures occur as the number of cycles per RF hour increase).

A vibration-based health monitoring system according to the present disclosure monitors vibration of valves of a gas delivery system using one or more fiber Bragg grating (FBG) sensors. FBG sensors can be used to measure vibration levels and/or vibration signatures of one or more components of the valves. The vibration levels increase and/or a vibration signature of the valve changes in response to valve failures. The vibration-based health monitor detects the increase in the vibration level and/or the change in the vibration signature corresponding to a valve defect at an earlier stage (e.g., before significant degradation of substrate uniformity occurs). As a result, the valve can be replaced at an earlier stage before the valve adversely impacts substrate yield. The FBG sensors can also be used to sensor pressure and/or temperature.

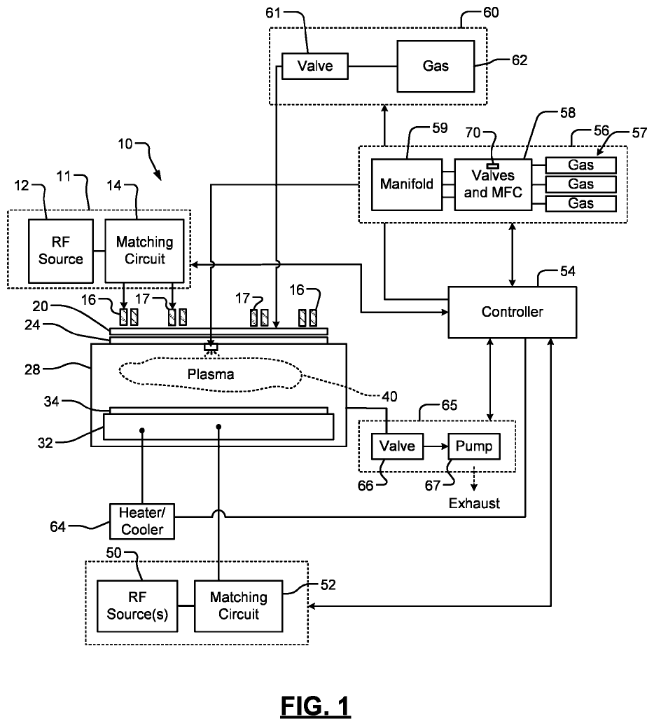

Referring now to FIG. 1, an example of a substrate processing system 10 is shown for purposes of illustration. While the present disclosure will be described in the context of inductively coupled plasma (ICP) substrate processing systems for performing atomic layer etching (ALE), the vibration-based health monitoring system can be used to monitor valves in other types of substrate treatments (e.g., such as capacitive coupled plasma (CCP), or other processes) that either use plasma and/or do not use plasma during substrate processing. The health monitoring system is configured to monitor a vibration level and/or signature of one or more valves of the gas delivery system and to generate a health indicator based on the monitored vibration level and/or signature of the one or more valves.

The substrate processing system 10 includes a coil driving circuit 11 with one or more RF sources 12 and one or more matching circuits 14. The coil driving circuit 11 supplies RF power to one or more inductive coils 16, 17 that are arranged adjacent to a processing chamber 28. The inductive coils 16, 17 are configured to selectively generate magnetic fields inside of the processing chamber when RF power is supplied to the inductive coils while process gas is supplied. The magnetic fields strike plasma in the processing chamber.

In some examples, a gas plenum 20 may be arranged between the inductive coils 16, 17 and a dielectric window 24 to control the temperature of the dielectric window 24 using hot and/or cold gas flow. The dielectric window 24 is arranged along one side of a processing chamber 28. The processing chamber 28 further comprises a substrate support (or pedestal) 32 to support a substrate 34 during processing. The substrate support 32 may include an electrostatic chuck (ESC), or a mechanical chuck or other type of chuck.

Process gas mixtures are supplied to the processing chamber 28 and plasma 40 is generated inside of the processing chamber 28. The plasma 40 etches an exposed surface of the substrate 34. An RF source 50 and matching circuit 52 may be used to bias the substrate support 32 during operation to control ion energy.

A gas delivery system 56 may be used to supply a process gas mixture to the processing chamber 28 during substrate treatment. In some examples, the process gas mixture supplies an etch gas mixture when etching is performed. The gas delivery system 56 may include process, purge and/or inert gas sources 57, a gas metering system 58 including valves and mass flow controllers (MFCs), and a manifold 59 for mixing the gases. Proper operation of the valves in the gas delivery system is required to start and stop the delivery of the gas mixtures during predetermined periods and to deliver the predetermined gas mixtures with the desired chemistry at a predetermined flow rate. While the valves may include pneumatically-controlled valves, other types of valves can be used.

A gas delivery system 60 may be used to deliver cooling gas 62 via a valve 61 to the gas plenum 20. The gas may include cooling gas (e.g., clean dry air (CDA)) that is used to cool the inductive coils 16 and the dielectric window 24. A heater/cooler 64 may be used to heat/cool the substrate support 32 to a predetermined temperature. For example, the substrate support 32 may include cooling channels to receive liquid coolant and/or embedded heaters such as resistive heaters in the substrate support 32. An exhaust system 65 includes a valve 66 and pump 67 to remove reactants from the processing chamber 28 by purging or evacuation.

A controller 54 may be used to control actuators during the substrate treatment in response to sensed system parameters. For example, the controller 54 monitors the system parameters and controls delivery of the gas mixture (e.g., by monitoring the MFCs and adjusting operation of the valves), striking, maintaining, and extinguishing the plasma, removal of reactants, supply of cooling gas to the gas plenum 20, etc. As will be described further below, operation of the valves in the gas metering system 58 is monitored by one or more FBG sensors 70 that detect vibration levels or signatures of the valves (or pressure or temperature).

Referring now to FIG. 2, an example of a valve 100 of the gas delivery system 56 is shown. In FIG. 2, the valve 100 includes a manifold 101, a carrier 102, and a diaphragm 103 arranged in the manifold 101. The valve 100 further includes a bonnet 104, a button 105, and a lower cylinder 106. The button 105 is arranged on one surface of the diaphragm 103.

The valve 100 further includes a cylinder 107 (connected to the cylinder 106), a cap 108 (connected to the cylinder 107). The valve 100 includes a gas fitting 110 and a thread insert 111 such as a helicoil insert. The valve 100 includes a set screw 112 and a piston 113. The valve 100 includes a piston 117 (connected to the piston 113), a spring 118, and seats 119 and 120. O-rings 114, 115, and 116 provide a seal between the piston 113 and the cap 108, between the piston 113 and the cylinder 107, and between the piston 117 and the cylinder 106, respectively. The spring 118 biases the piston 117 against the button 105 and the diaphragm 103.

When pneumatic valves are used, compressed gas moves the diaphragm 103 between first and second positions to move the pistons 113, 117 to open and close the valve 100. As components of the valves fail, vibration of the valve 100 increases. For example, when the diaphragm 103 of the valve 100 leaks, gas flows by the diaphragm 103 and increases vibration of the valve 100.

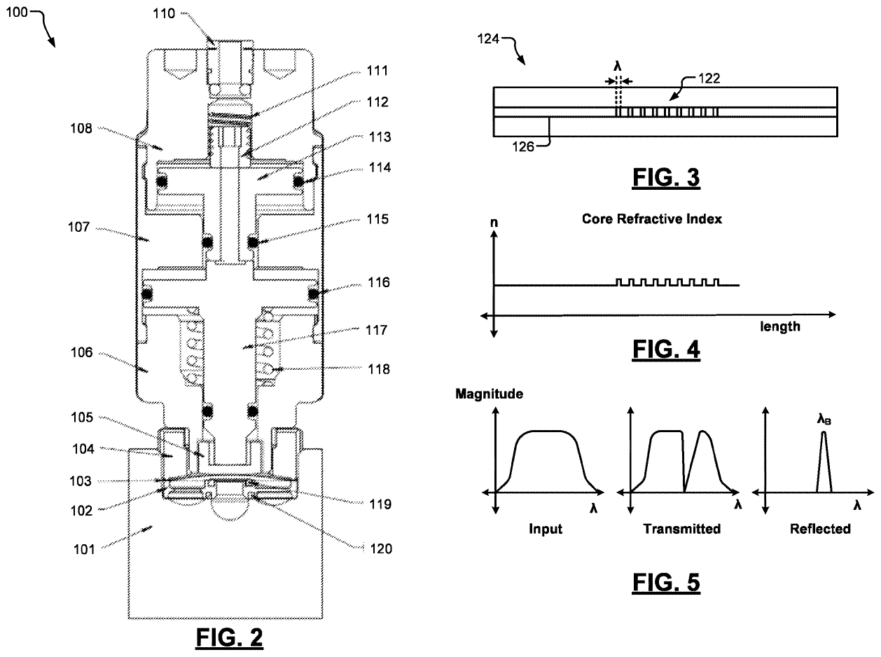

Referring now to FIGS. 3-5, a health monitoring system according to the present disclosure uses one or more FBG (FBG) sensors to monitor vibration, temperature, or pressure of a valve. For example, the health monitoring system according to the present disclosure measures the vibration level and/or vibration signature during different operating conditions and compares the measured vibration level to one or more predetermined vibration thresholds and/or compares the measured vibration signature to one or more predetermined vibration signatures. The health monitoring system diagnoses operation of the one or more components of the valve and/or estimates a health of the one or more components of the valve based thereon. In other examples, pressure or temperature are monitored. For examples, pressure inside of the valve can be monitored to detect a crack in a diaphragm.

In FIG. 3, a FBG sensor 122 is a type of distributed Bragg reflector arranged in an optical fiber 124. The FBG sensor 122 is configured to reflect predetermined wavelengths of light and transmit other wavelengths of light. The distributed Bragg reflector in the optical fiber 124 includes a periodic variation in the refractive index n of a fiber core 126 between two or more refractive indexes (e.g., an effective refractive index ne). The periodic variation in the refractive index creates a wavelength-specific dielectric mirror. In FIG. 4, the core refractive index varies within the FBG sensor 122. When using more than one FBG sensor 122 connected in a chain, the FBG sensors may include different effective refractive indexes to allow vibration to be measured at different locations without overlapping responses.

In FIG. 5, examples of magnitudes of input, transmitted and reflected spectral responses are shown for the FBG sensor 122. The wavelength AB of the reflected spectral response (or vibration signature) is related to the effective refractive index ne and the wavelength A of the transmitted input. As will be described further below, the FBG sensors 122 can be arranged either inside of the housing of the valve and/or outside of the housing of the valve.

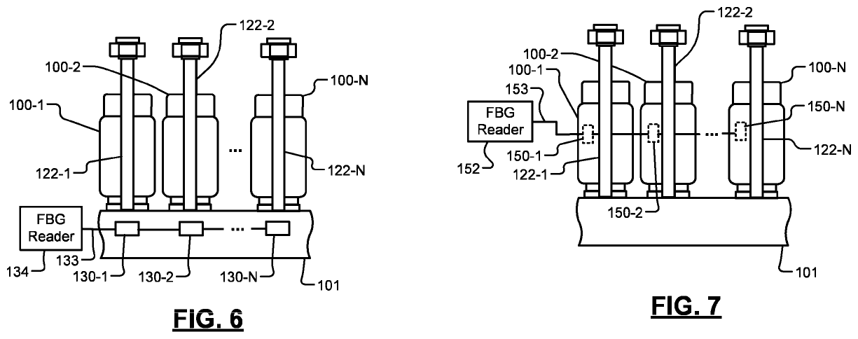

In FIG. 6, valves 100-1, 100-2, . . . , and 100-N are connected to the manifold 101. In some examples, FBG sensors 130-1, 130-2, . . . , and 130-N are arranged on the manifold 101 adjacent to the corresponding one of the valves 100-1, 100-2, . . . , and 100-N. The FBG sensors 130-1, 130-2, . . . , and 130-N sense vibration, temperature, or pressure of the valves 100-1, 100-2, . . . , and 100-N, respectively.

An FBG reader 134 generates an input signal on an optical fiber 133 and receives the reflected signals from the FBG sensors 130-1, 130-2, . . . , and 130-N via the optical fiber 133. In some examples, the FBG sensors 130-1, 130-2, . . . , and 130-N are connected to the optical fiber 133 in a chain (or multiple optical fibers and/or readers are used). In some examples, the FBG sensors 130-1, 130-2, . . . , and 130-N have different effective refractive indexes to provide non-overlapping reflected signals to allow the vibration levels to be detected at separate locations.

In some examples, the FBG sensors 130-1, 130-2, . . . , and 130-N are attached to the manifold 101 or other mounting surfaces using tape (e.g., Kapton tape) and/or adhesive. In addition to sensing vibration, the FBG sensors 130-1, 130-2, . . . , and 130-N can also be used to monitor temperature changes and/or pressure changes (e.g., when installed within a housing of the valve). For corrosive applications, the FBG sensors 130-1, 130-2, . . . , and 130-N can be coated with a chemical resistant layer such as ceramic and/or encapsulated in a tube made of a chemically resistant material.

Referring now to FIGS. 7 to 9, one or more FBG sensors can be arranged inside of the housings of the valves. In FIG. 7, one or more FBG sensors 150-1, 150-2, . . . , and 150-P are attached to one or more components located inside of housings of the valves 100-1, 100-2, . . . , and 100-N and connected by optical fiber 153 to an FBG reader 152 to detect vibration levels and/or signatures for the one or more components during operation.

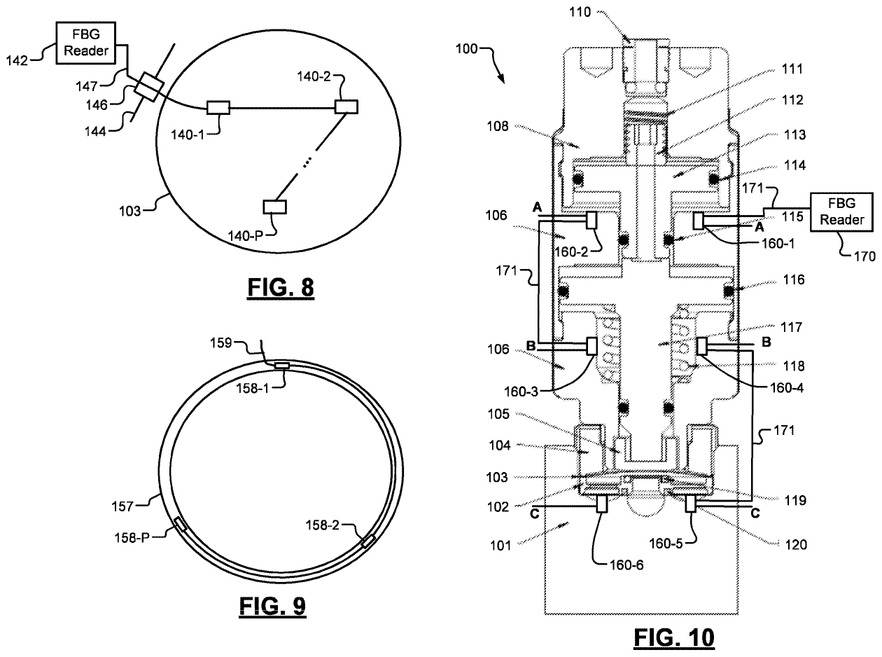

In FIG. 8, one or more FBG sensors 140-1, 140-2, . . . , and 140-P are attached to and/or embedded in the diaphragm 103 and connected by optical fiber 147 to an FBG reader 142 to detect a vibration level or signature at one or more portions of the diaphragm 103. A fiber feedthrough 146 may be used to feed the optical fiber 147 through an opening in a housing 144 of the valve. In some examples, the fiber feedthrough 146 can be made of metal that is welded, brazed, or bonded in the opening of the housing 144. In other examples, the fiber feedthrough 146 can be made of a metallic or non-metallic material that is bonded to the opening of the housing 144 using adhesive.

In FIG. 9, one or more FBG sensors 158-1, 158-2, . . . , and 158-P are attached to and/or embedded in an O-ring 157. The one or more FBG sensors 158-1, 158-2, . . . , and 158-P are connected to an FBG reader by an optical fiber 159 to detect vibration of the O-ring 157.

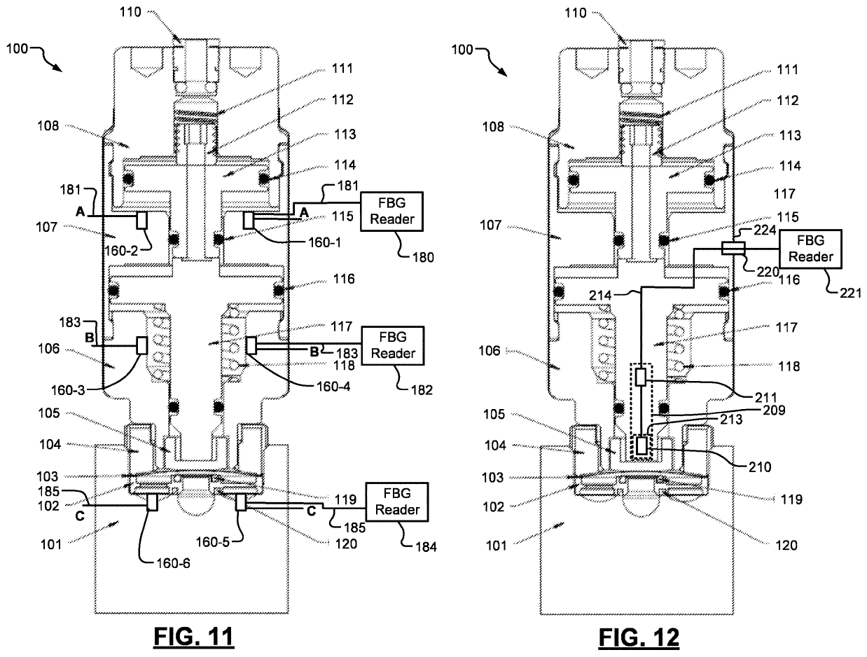

Referring now to FIGS. 10 and 11, the valve 100 includes one or more FBG sensors arranged inside of the housing of the valve 100. For example, FBG sensors 160-1, 160-2 are attached to an outer surface of or embedded in the cylinder 107, FBG sensors 160-3, 160-4 are embedded in the lower cylinder 106 near the spring 118, and FBG sensors 160-5, 160-6 are arranged in the manifold 101 near the diaphragm 103. While specific locations are shown for purposes of illustration, FBG sensors can be arranged in other locations.

In FIG. 10, a single FBG reader 170 is configured to read the FBG sensors 160-1 and 160-2 (connected at A), 160-3 and 160-4 (connected at B), and 160-5 and 160-6 (connected at C). In other words, the FBG sensors 160-1, 160-2, 160-3, 160-4, 160-5, and 160-6 are connected in a chain to a single optical fiber. While the connections A, B and C are shown extending outside of the housing of the valve in FIG. 10, the connections A, B and/or C can be made inside of the housing of the valve.

In FIG. 11, multiple FBG readers 180, 182, and 184 can also be used. The FBG reader 180 reads FBG sensors 160-1, 160-2 (via optical fiber 181 connected at A), the FBG reader 182 reads FBG sensors 160-3, 160-4 (via optical fiber 183 connected at B), and the FBG reader 184 reads FBG sensors 160-5, 160-6 (via optical fiber 185 connected at C). While the connections A, B and C are shown extending outside of the housing of the valve in FIG. 11, the connections A, B and/or C can be made inside of the housing of the valve.

In FIG. 12, the valve includes FBG sensors 210 and 211 that are arranged in the lower piston 117. As can be appreciated, the FBG sensors can be constrained (e.g., attached) or unconstrained (e.g., detached) to provide detect different types of vibration measurement and/or calibration. In some examples, the lower piston 117 includes a cavity 209 and the FBG sensors 210 and 211 are arranged in the cavity 209. In some examples, the sensor 210 is constrained since it is attached by a material 213 such as epoxy or molding material within the cavity 209. The sensor 211 is unconstrained since it is not attached to inner surfaces of the cavity 209. As can be appreciated, the FBG sensors 210 and 211 will respond to vibration differently, which can be used for calibration and/or to diagnose different types of faults. For example, the FBG sensor 211 is more sensitive to vibration than the FBG sensor 210. The FBG sensor 211 can be used to calibrate the FBG sensor 210. In other examples, the FBG sensor 211 can be used to detect other types of faults associated with lower levels of vibration.

An optical fiber 214 extends through the lower piston 117 and a fiber feedthrough 220 arranged in an opening in a housing 224 of the valve 100. An FBG reader 221 reads the FBG sensor 210.

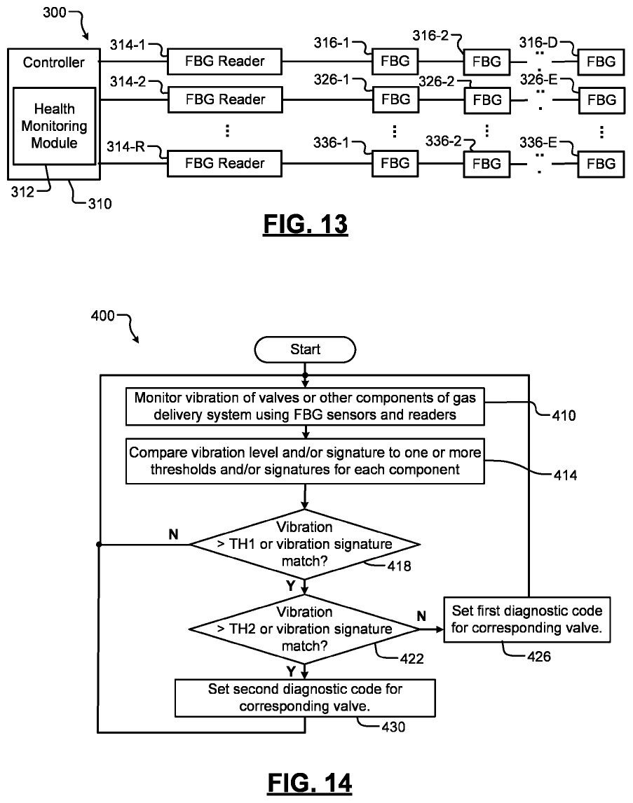

Referring now to FIG. 13, a health monitoring system 300 includes a controller 310 including a health monitoring module 312 configured to monitor vibration of one or more valves. The controller 310 communicates with FBG readers 314-1, 314-1, . . . , and 314-R. The FBG reader 314-1 reads one or more FBG sensors 316-1, 316-2, . . . , and 316-D. The FBG reader 314-2 reads one or more FBG sensors 326-1, 326-2, . . . , and 326-E. The FBG reader 314-R reads one or more FBG sensors 336-1, 336-2, . . . , and 336-F. In some examples, D, E, F, and R are integers greater than zero.

The health monitoring module 312 is configured to determine a frequency of vibration measurements, measure vibration, compare the measured vibration levels to one or more thresholds, compare the measured vibration signatures to one or more predetermined vibration signatures corresponding to different operational states, generate diagnostic signals, and/or estimate a health or remaining life of the valve based thereon. For example, decreases in the health of the valve can be declared in response to increases in the measured vibration level above successively higher vibration levels. For example, decreases in the health of the valve can be declared in response to correlation value between a vibration signature of the valve and a vibration signature of a failed valve. Higher correlation levels correspond to lower remaining life.

Referring now to FIG. 14, a method 400 for monitoring vibration of valves is shown. At 410, vibration of valves of a gas delivery system are monitored using one or more FBG sensors and one or more readers. At 414, vibration levels and/or vibration signatures are compared to one or more predetermined vibration thresholds and/or one or more predetermined vibration signatures for each component, respectively. At 418, the method determines whether the measured vibration is greater than a first vibration threshold (e.g., corresponding to an elevated vibration level) (and/or sufficiently correlates with a first vibration signature (e.g., corresponding to a first elevated vibration level)). If 418 is false, then the method returns to 410.

If 418 is true, the method continues at 422 and determines whether the measured vibration is greater than a second vibration threshold (e.g., corresponding to abnormally high vibration level) (and/or sufficiently correlates with a second vibration signature (e.g., corresponding to a second elevated vibration level)). If 422 is false, then the method continues at 426 and sets a first diagnostic code for the corresponding valve.

If 422 is true, the method continues at 430 and sets a second diagnostic code for the corresponding valve. In some examples, the health monitoring module estimates a health or remaining life of the valve based on current and/or prior vibration levels at 426 and/or 430 and/or a rate of change of the vibration level. In some examples, the health monitoring module estimates a health or remaining life of the valve based on current and/or prior vibration signatures at 426 and/or 430.

The vibration-based health monitoring system according to the present disclosure monitors vibration levels and/or signatures of valves of the gas delivery system. The measured vibration levels and/or signatures are used to identify a faulty valve, to detect a valve that is starting to fail, and/or to estimate a useful life and/or health of the valves. The vibration-based health monitoring system enables proactive identification of valves that are likely to fail sooner to allow replacement prior to failure. As a result, the substrate processing system will have improved substrate uniformity and fewer defects.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In some implementations, a controller is part of a system, which may be part of the above-described examples. Such systems can comprise semiconductor processing equipment, including a processing tool or tools, chamber or chambers, a platform, or platforms for processing, and/or specific processing components (a wafer pedestal, a gas flow system, etc.). These systems may be integrated with electronics for controlling their operation before, during, and after processing of a semiconductor wafer or substrate. The electronics may be referred to as the “controller,” which may control various components or subparts of the system or systems. The controller, depending on the processing requirements and/or the type of system, may be programmed to control any of the processes disclosed herein, including the delivery of processing gases, temperature settings (e.g., heating and/or cooling), pressure settings, vacuum settings, power settings, radio frequency (RF) generator settings, RF matching circuit settings, frequency settings, flow rate settings, fluid delivery settings, positional and operation settings, wafer transfers into and out of a tool and other transfer tools and/or load locks connected to or interfaced with a specific system.

Broadly speaking, the controller may be defined as electronics having various integrated circuits, logic, memory, and/or software that receive instructions, issue instructions, control operation, enable cleaning operations, enable endpoint measurements, and the like. The integrated circuits may include chips in the form of firmware that store program instructions, digital signal processors (DSPs), chips defined as application specific integrated circuits (ASICs), and/or one or more microprocessors, or microcontrollers that execute program instructions (e.g., software). Program instructions may be instructions communicated to the controller in the form of various individual settings (or program files), defining operational parameters for carrying out a particular process on or for a semiconductor wafer or to a system. The operational parameters may, in some embodiments, be part of a recipe defined by process engineers to accomplish one or more processing steps during the fabrication of one or more layers, materials, metals, oxides, silicon, silicon dioxide, surfaces, circuits, and/or dies of a wafer.

The controller, in some implementations, may be a part of or coupled to a computer that is integrated with the system, coupled to the system, otherwise networked to the system, or a combination thereof. For example, the controller may be in the “cloud” or all or a part of a fab host computer system, which can allow for remote access of the wafer processing. The computer may enable remote access to the system to monitor current progress of fabrication operations, examine a history of past fabrication operations, examine trends or performance metrics from a plurality of fabrication operations, to change parameters of current processing, to set processing steps to follow a current processing, or to start a new process. In some examples, a remote computer (e.g., a server) can provide process recipes to a system over a network, which may include a local network or the Internet. The remote computer may include a user interface that enables entry or programming of parameters and/or settings, which are then communicated to the system from the remote computer. In some examples, the controller receives instructions in the form of data, which specify parameters for each of the processing steps to be performed during one or more operations. It should be understood that the parameters may be specific to the type of process to be performed and the type of tool that the controller is configured to interface with or control. Thus, as described above, the controller may be distributed, such as by comprising one or more discrete controllers that are networked together and working towards a common purpose, such as the processes and controls described herein. An example of a distributed controller for such purposes would be one or more integrated circuits on a chamber in communication with one or more integrated circuits located remotely (such as at the platform level or as part of a remote computer) that combine to control a process on the chamber.

Without limitation, example systems may include a plasma etch chamber or module, a deposition chamber or module, a spin-rinse chamber or module, a metal plating chamber or module, a clean chamber or module, a bevel edge etch chamber or module, a physical vapor deposition (PVD) chamber or module, a chemical vapor deposition (CVD) chamber or module, an atomic layer deposition (ALD) chamber or module, an atomic layer etch (ALE) chamber or module, an ion implantation chamber or module, a track chamber or module, and any other semiconductor processing systems that may be associated or used in the fabrication and/or manufacturing of semiconductor wafers.

As noted above, depending on the process step or steps to be performed by the tool, the controller might communicate with one or more of other tool circuits or modules, other tool components, cluster tools, other tool interfaces, adjacent tools, neighboring tools, tools located throughout a factory, a main computer, another controller, or tools used in material transport that bring containers of wafers to and from tool locations and/or load ports in a semiconductor manufacturing factory.

What is claimed is:

1. A health monitoring system for a valve of a gas delivery system, comprising:
a fiber Bragg grating sensor configured to measure vibration of the valve of the gas delivery system;
an optical fiber connected to the fiber Bragg grating sensor; and
a reader connected to the optical fiber and configured to read the fiber Bragg grating sensor and generate a vibration signal.

2. The health monitoring system of claim 1, further comprising a controller configured to receive the vibration signal and to generate a valve health indicator for the valve based on the vibration signal.

3. The health monitoring system of claim 1, further comprising:
the valve; and
a manifold connected to the valve,
wherein the fiber Bragg grating sensor is attached to the manifold.

4. The health monitoring system of claim 1, further comprising:
the valve,
wherein the valve includes a diaphragm, and
wherein the fiber Bragg grating sensor is attached to the diaphragm.

5. The health monitoring system of claim 1, further comprising:
the valve,
wherein the valve includes:
a housing;
a feedthrough arranged in an opening in the housing; and
a valve component arranged in the housing,
wherein the fiber Bragg grating sensor is attached to the valve component, and
wherein the optical fiber passes through the feedthrough and is connected to the fiber Bragg grating sensor attached to the valve component.

6. The health monitoring system of claim 5, wherein the feedthrough is welded to the housing.

7. The health monitoring system of claim 5, wherein the feedthrough is bonded to the housing.

8. The health monitoring system of claim 1, further comprising:
the valve,
wherein the valve includes at least one of an upper piston and a lower piston,
wherein the fiber Bragg grating sensor is one of attached to the at least one of the upper piston and the lower piston.

9. The health monitoring system of claim 2, wherein the controller is configured to compare the vibration signal to a predetermined vibration signature and to generate the valve health indicator in response to the comparison.

10. The health monitoring system of claim 2, wherein the controller is configured to compare the vibration signal to a predetermined vibration threshold and to generate the valve health indicator in response to the comparison.

11. The health monitoring system of claim 1, wherein the gas delivery system includes a plurality of the fiber Bragg grating sensor to sense vibration at a plurality of locations of the valve.

12. The health monitoring system of claim 11, wherein the plurality of the fiber Bragg grating sensor are arranged along a length of the optical fiber.

13. The health monitoring system of claim 11, further comprising the valve, wherein the valve comprises a pneumatic valve.

14. The health monitoring system of claim 1, wherein the fiber Bragg grating sensor is constrained and further comprising a second fiber Bragg grating sensor that is unconstrained.

15. A method for monitoring health of a valve of a gas delivery system, comprising:
sensing vibration of the valve of the gas delivery system using a fiber Bragg grating sensor;
coupling light between the fiber Bragg grating sensor and a reader using an optical fiber; and
reading the fiber Bragg grating sensor to sense vibration of the valve of the gas delivery system and generating a vibration signal.

16. The method of claim 15, further comprising generating a valve health indicator for the valve of the gas delivery system based on the vibration signal.

17. The method of claim 15, further comprising attaching the fiber Bragg grating sensor to a manifold connected to the valve.

18. The method of claim 15, further comprising attaching the fiber Bragg grating sensor to a diaphragm of the valve.

19. The method of claim 15, further comprising:
arranging the fiber Bragg grating sensor in a housing of the valve;
using a feedthrough arranged in an opening in the housing; and
feeding the optical fiber through the feedthrough to the fiber Bragg grating sensor.

20. The method of claim 19, further comprising welding the feedthrough in the opening of the housing.

21. The method of claim 19, further comprising bonding the feedthrough in the opening of the housing.

22. The method of claim 16, further comprising comparing the vibration signal to a predetermined vibration signature and generating the valve health indicator in response to the comparison.

23. The method of claim 16, further comprising comparing the vibration signal to a predetermined vibration threshold and generating the valve health indicator in response to the comparison.

24. The method of claim 15, further comprising:
using a plurality of the fiber Bragg grating sensor;
constraining a first one of the plurality of the fiber Bragg grating sensor; and
not constraining a second one of the plurality of the fiber Bragg grating sensor.

25. The method of claim 24, further comprising calibrating the first one of the plurality of the fiber Bragg grating sensor using the second one of the plurality of the fiber Bragg grating sensor.

26. A health monitoring system for a valve of a gas delivery system, comprising:
a fiber Bragg grating sensor configured to measure pressure in a valve isolation chamber of the valve to detect a crack in a diaphragm of the valve during operation.
an optical fiber connected to the fiber Bragg grating sensor; and
a reader connected to the optical fiber and configured to read the fiber Bragg grating sensor and generate a pressure signal in response to the measured pressure in the valve isolation chamber.

27. The health monitoring system of claim 1, wherein the optical fiber extends through the valve.

28. The health monitoring system of claim 3, further comprising:
another optical fiber connected to the valve; and
another fiber Bragg grating sensor connected to or integral to the another optical fiber.

29. The health monitoring system of claim 28, wherein:
the vibration signal is indicative of vibration at the valve; and
the reader is connected to the another fiber Bragg grating sensor and configured to read the another fiber Bragg grating sensor and, based on the reading of the another fiber Bragg grating sensor, generate at least one of the vibration signal and another vibration signal indicative of the vibration at the valve.

30. The health monitoring system of claim 28, wherein the fiber Bragg grating sensor attached to the manifold is located at an end of the another optical fiber.

31. The health monitoring system of claim 4, further comprising a plurality of fiber Bragg grating sensors, wherein:
the plurality of fiber Bragg grating sensors include the fiber Bragg grating sensor connected to the optical fiber; and
the plurality of fiber Bragg grating sensors are disposed within a housing of the diaphragm along the optical fiber to detect vibration of the diaphragm.

32. The health monitoring system of claim 31, wherein the optical fiber is disposed within the housing of the diaphragm.

33. The health monitoring system of claim 1, further comprising a plurality of fiber Bragg grating sensors, wherein:
the plurality of fiber Bragg grating sensors include the fiber Bragg grating sensor connected to the optical fiber; and
the optical fiber extends along an O-ring of the valve.
